(19) United States
(12) Patent Application Publication
(10) Pub. No.: US 2026/0298658 A1
(43) Pub. Date: Oct. 1, 2026

(54) METHOD FOR GENERATING A MAP REPRESENTATION FOR A VEHICLE

(71) Applicant: Robert Bosch GmbH, Stuttgart (DE)

(72) Inventors: Thorben Funke, Sarstedt (DE); Andre Wagner, Barcelona (ES); Henning von Zitzewitz, Hemmingen (DE)

(21) Appl. No.: 19/574,927

(22) Filed: Mar. 23, 2026

(30) Foreign Application Priority Data
Mar. 31, 2025 (DE) 10 2025 112 431.0

(51) Int. Cl. G01C 21/00; G01S 13/89

(52) U.S. Cl. CPC G01C 21/3822; G01C 21/3837; G01C 21/3867; G01S 13/89

(57) ABSTRACT

A computer-implemented method for generating a map representation for a vehicle. The method includes: receiving environmental sensor data of at least one environmental sensor of the vehicle by means of an onboard map generation system, wherein the environmental sensor data at least partially represent an environment of the vehicle; receiving map data of an electronic road map by means of the onboard map generation system, wherein the map data at least partially represent a traffic infrastructure within the environment of the vehicle, and wherein the map data are based on radar data; and generating the map representation of the environment of the vehicle based on the environmental sensor data and the map data using the onboard map generation system.

### CROSS REFERENCE

The present application claims the benefit under 35 U.S.C. § 119 of Germany Patent Application No. DE 10 2025 112 431.0 filed on Mar. 31, 2025, which is expressly incorporated herein by reference in its entirety.

### FIELD

The present disclosure relates to a method for generating a map representation for a vehicle.

### BACKGROUND INFORMATION

Certain methods for generating maps for vehicles are described in the related art.

It is an object of the present disclosure to provide an improved method for generating a map representation for a vehicle.

### SUMMARY

The object may be achieved by a method having certain features of the present application. Advantageous example embodiments are disclosed herein.

According to one aspect, a computer-implemented method for generating a map representation for a vehicle is provided. According to an example embodiment, the method comprising: receiving environmental sensor data of at least one environmental sensor of the vehicle by means of an onboard map generation system, wherein the environmental sensor data at least partially represent an environment of the vehicle;
receiving map data of an electronic road map by means of the on-board map generation system, wherein the map data at least partially represent a traffic infrastructure within the environment of the vehicle, and wherein the map data are based on radar data; and
generating the map representation of the environment of the vehicle based on the environmental sensor data and the map data by means of the onboard map generation system.

This can achieve the technical advantage that an improved method for generating a map representation for a vehicle can be provided. For this purpose, an onboard map generation system first receives environmental sensor data of at least one environmental sensor of the vehicle, which data at least partially represent the environment of the vehicle.

Moreover, the onboard map generation system receives map data of an electronic road map. The map data at least partially represent a traffic infrastructure within the environment of the vehicle. The map data of the electronic road map are based on radar data.

Subsequently, the onboard map generation system generates a map representation of the environment based on the environmental sensor data and the map data of the electronic road map.

According to the present disclosure, the map representation is generated in an onboard map generation process during the operation of the vehicle.

In contrast, the electronic road map is based on historical data from a plurality of vehicles during a plurality of passes and includes conventional information regarding the traffic infrastructure of electronic road maps.

For the purposes of the application, the electronic road map is used as a map prior for generating the map representation.

According to one example embodiment, the method further comprises:
receiving radar data of at least one radar sensor of the vehicle, wherein the radar data at least partially represent the environment of the vehicle, and wherein the map representation is generated taking into account the radar data.

This can achieve the technical advantage that a further improvement of the map representation can be provided. For this purpose, in addition to the environmental sensor data and the map data, the onboard map generation system also receives radar data from at least one radar sensor of the vehicle.

The radar data at least partially represent the environment of the vehicle. The map representation is generated taking the radar data into account.

By means of the radar data, additional information that cannot be provided by the environmental sensor data or the electronic road map can be taken into account in the map representation.

According to one example embodiment, the map data of the road map are based on aggregated and/or filtered radar data.

This can achieve the technical advantage that, by means of the map data of the electronic road map, a representation of the traffic infrastructure that is as precise as possible can be provided by means of the aggregated and/or filtered radar data of the map data of the electronic road map.

According to one example embodiment, the map data comprise information from the following list: radar cross section, frame counter, mean position, covariance.

This can achieve the technical advantage that the information provided by the map data of the electronic road map can be made even more precise.

According to one example embodiment, the environmental sensor data comprise image data and/or video data, and/or wherein the method further comprises:
converting the environmental sensor data into bird's-eye view features by means of a transformer of a BEV backbone of the onboard map generation system;
converting the radar data into bird's-eye view features by means of a radar perception encoder of the onboard map generation system;
extracting map features based on the bird's-eye view features of the environmental sensor data, the bird's-eye view features of the radar data, and the bird's-eye view features of the map data by means of a map head of the onboard map generation system; and generating the map representation based on the map features by means of a map prediction module of the onboard map generation system.

This can achieve the technical advantage that a high-performance map representation based on the environmental sensor data, radar data and map data of the electronic road map can be provided.

According to one example embodiment, the method further comprises:
generating bird's-eye view features of the map data of the road map by a radar encoder of the onboard map generation system.

This can achieve the technical advantage that precise consideration of the information of the map data of the road map during generation of the map representation is made possible.

According to one example embodiment, the method further comprises:
fusing the bird's-eye view features of the map data with the bird's-eye view features of the environmental sensor data and the bird's-eye view features of the radar data.

This can achieve the technical advantage that, by fusing the bird's-eye view features of the map data with the bird's-eye view features of the environmental sensor data and the bird's-eye view features of the radar data, the information of the electronic road map can be precisely integrated into the information of the environmental sensor data and radar data.

According to one example embodiment, fusing the bird's-eye view features of the map data with the bird's-eye view features of the environmental sensor data and the bird's-eye view features of the radar data is effected by means of a process from the following list: addition of features, concatenation of features and processing by an artificial intelligence, cross attention.

This can achieve the technical advantage that a high-performance fusion of the information of the map data of the electronic road map with the environmental sensor data and the radar data is made possible.

According to one aspect, a computing unit is provided that is configured to carry out the method for generating a map representation for a vehicle according to one of the above-described embodiments.

According to one aspect, a computer program product is provided which comprises commands that, when the program is executed by a data processing unit, cause the data processing unit to carry out the method for generating a map representation for a vehicle according to one of the above-described embodiments.

Example embodiments of the present disclosure are described with reference to the figures.

### BRIEF DESCRIPTION OF THE DRAWINGS

FIG. 1 is a graphical representation of an onboard map generation system for generating a map representation for a vehicle according to one example embodiment.

FIG. 2 is a flow chart of a method for generating a map representation according to one example embodiment.

FIG. 3 is a further flow chart of the method for generating a map representation according to a further example embodiment.

FIG. 4 is a schematic representation of a computer program product, according to an example embodiment.

### DETAILED DESCRIPTION OF EXAMPLE EMBODIMENTS

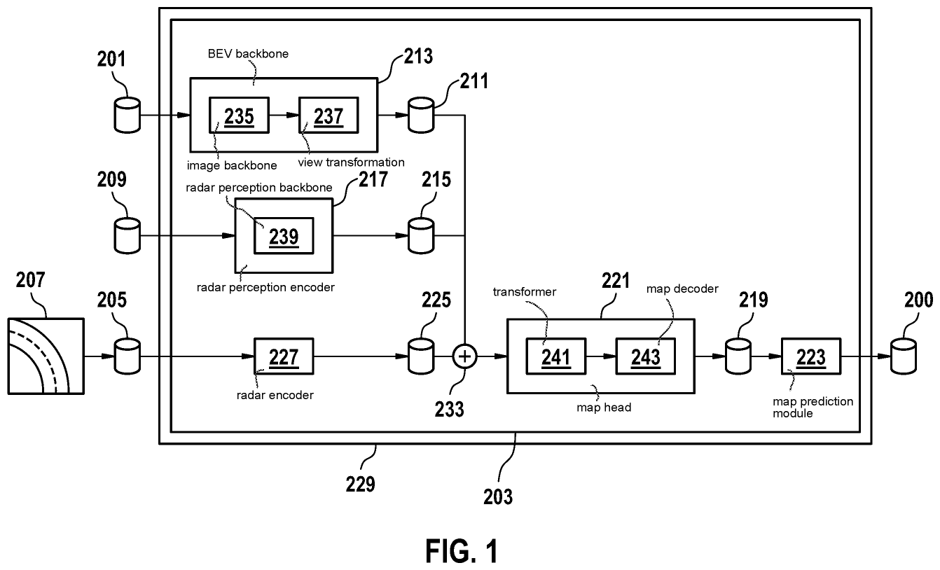

FIG. 1 is a graphical representation of an onboard map generation system 203 for generating a map representation 200 for a vehicle according to one embodiment.

According to the present disclosure, the onboard map generation system 203 shown is configured to generate a map representation 200 based on environmental sensor data 201 of at least one environmental sensor of the vehicle and on map data 205 of an electronic road map 207.

The map representation 200 is generated in an onboard map generation process during operation of the vehicle and at least partially represents the environment of the vehicle.

According to the present disclosure, the electronic road map 207 is based on radar data that were created as historical data by a plurality of vehicles during a plurality of passes within the environment of the vehicle.

The electronic road map 207 at least partially represents a traffic infrastructure within the environment of the vehicle and comprises information regarding the traffic infrastructure, as is the case of certain electronic road maps from the related art.

For the purposes of the application, the electronic road map 207 is used as a map prior in accordance with the related art during generation of the map representation 200.

The map representation 200 generated by the onboard map generation system 203 comprises information regarding the traffic infrastructure provided by the electronic road map 207 and information regarding the environment of the vehicle provided by the environmental sensor data 201.

In FIG. 1, the onboard map generation system 203 is executed on a computing unit 229 of the vehicle (not shown).

In the embodiment shown, the onboard map generation system 203 is further configured to receive radar data 209 of at least one radar sensor of the vehicle and to integrate it into the generation of the map representation 200. Here, the radar data at least partially represent the environment of the vehicle.

According to one embodiment, the map data of the electronic road map 207 are based on aggregated and/or filtered radar data, which were recorded as historical data by the plurality of different vehicles during the plurality of different passes.

According to one embodiment, the map data 205 of the electronic road map 207 comprise information from the following list: radar cross section, frame counter, mean position, covariance.

In the embodiment shown, the onboard map generation system 203 comprises a bird's-eye view BEV backbone 213 with an image backbone 235 and a view transformation 237. Via the BEV backbone 213, the onboard map generation system 203 is configured to convert the environmental sensor data 201, which is in the form of image data and/or video data, into bird's-eye view BEV features 211.

The onboard map generation system 203 further comprises a radar perception encoder 217 having a radar perception backbone 239. Via the radar perception encoder 217, the onboard map generation system 203 is configured to convert the radar data 209 of the at least one radar sensor into bird's-eye view BEV features 215.

In the embodiment shown, the onboard map generation system 203 further comprises a radar encoder 227. Via the radar encoder 227, the onboard map generation system 203 is configured to convert the map data 205 of the electronic road map 207 into corresponding bird's-eye view BEV features 225.

In the embodiment shown, to generate the map representation 200, the BEV features 211 of the environmental sensor data 201, the BEV features 215 of the radar data 209, and the BEV features 225 of the map data 205 are fused together in a fusion 233.

In the embodiment shown, the onboard map generation system 203 further comprises a map head 221 having a transformer 241 and a map decoder 243. Via the map head 221, the onboard map generation system 203 is configured to generate map features 219 based on the fused bird's-eye view features 211, 215, 225 of the environmental sensor data 201, the radar data 209 and the map data 205.

Via a map prediction module 223, the onboard map generation system 203 is ultimately able to generate the map representation 200 based on the map features 219.

According to one embodiment, the environmental sensor data 201 are converted, in the BEV backbone 213, into corresponding BEV features 215 according to Yang et al.: C. Yang, Y. Chen, H. Tian, C. Tao, X. Zhu, Z. Zhang, G. Huang, H. Li, Y. Qiao, L. Lu, et al., “Bevformer v2: Adapting modern image backbones to bird's-eye-view recognition via perspective supervision,” in Proceedings of the IEEE/CVF Conference on Computer Vision and Pattern Recognition, pp. 17830-17839, 2023.

According to one embodiment, the map representation 200 is generated based on the map features 219 by means of the map prediction module 223 according to B. Liao, S. Chen, X. Wang, T. Cheng, Q. Zhang, W. Liu, and C. Huang, “Maptr: Structured modeling and learning for online vectorized hd map construction,” arXiv preprint arXiv: 2208.14437, 2022 or T. Li, P. Jia, B. Wang, L. Chen, K. Jiang, J. Yan, and H. Li, “Lanesegnet: Map learning with lane segment perception for autonomous driving,” arXiv preprint arXiv: 2312.16108, 2023.

According to one embodiment, the radar encoder 227 is designed to convert the map data 205 of the electronic road map 207 into the corresponding BEV features 225 according to Ulrich et al.: M. Ulrich, S. Braun, D. Köhler, D. Niederlöhner, F. Faion, C. Gläser, and H. Blume, “Improved orientation estimation and detection with hybrid object detection networks for automotive radar,” in 2022 IEEE 25th International Conference on Intelligent Transportation Systems (ITSC), pp. 111-117, IEEE, 2022.

According to one embodiment, the fusion 233 of the BEV features 211 of the environmental sensor data 201, the BEV features 215 of the radar data 209 and the BEV features 225 of the map data 205 is effected via a concatenation of the corresponding BEV features 211, 215, 225 and the execution of a downstream convolutional neural network, or by executing a cross attention mechanism. In this case, the fusion 233 can be effected according to Wu et al.: H. Wu, Z. Zhang, S. Lin, T. Qin, J. Pan, Q. Zhao, C. Xu, and M. Yang, “Blos-bev: Navigation map enhanced lane segmentation network, beyond line of sight,” in 2024 IEEE Intelligent Vehicles Symposium (IV), pp. 3212-3219, IEEE, 2024.

According to one embodiment, the map head 221 is designed according to Liao et al. or according to Li et al.

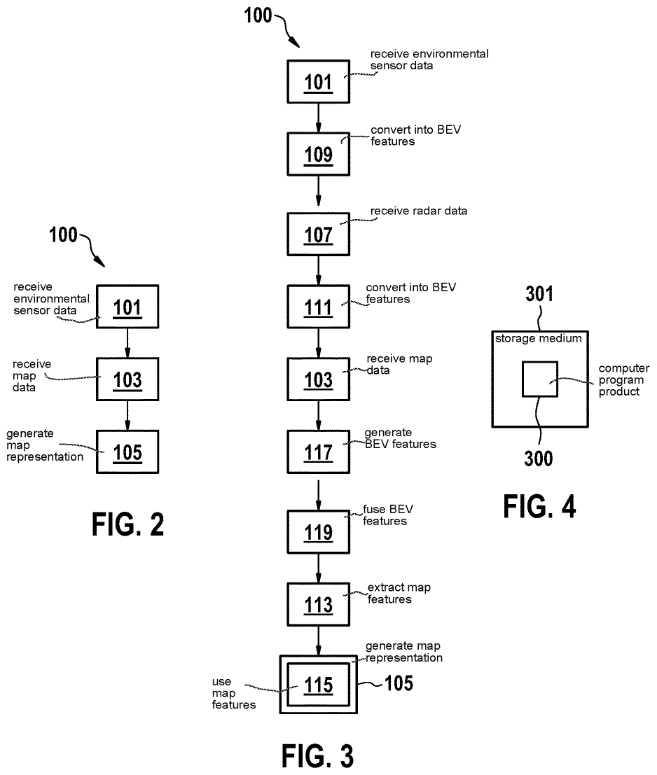

FIG. 2 is a flow chart of a method 100 for generating a map representation 200 according to one embodiment.

To generate a map representation 200 for a vehicle, in a first method step 101 the environmental sensor data 201 of the at least one environmental sensor of the vehicle are first received by the onboard map generation system 203.

In a further method step 103, the map data 205 of the electronic road map 207 are received by the onboard map generation system 203.

In a further method step 105, the map representation 200 is generated by the onboard map generation system 203 based on the environmental sensor data 201 and the map data 205.

FIG. 3 is a further flow chart of the method 100 for generating a map representation 200 according to a further embodiment.

The embodiment in FIG. 3 is based on the embodiment in FIG. 2 and includes all of the features described there.

In the embodiment shown, in a further method step 109 the environmental sensor data 201 are converted into BEV features 211 by the BEV backbone 213 of the onboard map generation system 203.

In a further method step 107, the radar data 209 of the at least one radar sensor of the vehicle are received by the onboard map generation system 203.

In a further method step 111, the radar data 209 are converted into the BEV features 215 by the radar perception encoder 217 of the onboard map generation system 203.

In a further method step 117, the BEV features 225 are generated by the radar encoder 227 of the onboard map generation system 203 based on the map data 205.

In a further method step 119, the BEV features 225 of the map data 205 are fused with the BEV features 211 of the environmental sensor data 201 and with the BEV features 215 of the radar data 209.

In a further method step 113, based on the fused BEV features 211 of the environmental sensor data, BEV features 215 of the radar data and BEV features 225 of the map data 205, the map features 219 are extracted by executing the map head 221 of the onboard map generation system 203.

In a further method step 115, the map representation 200 is generated by the map prediction module 223 of the onboard map generation system 203 based on the map features 219.

FIG. 4 is a schematic representation of a computer program product 300 comprising commands that, when the program is executed by a data processing unit, cause the data processing unit to carry out the method 100 for generating a map representation 200 for a vehicle.

In the embodiment shown, the computer program product 300 is stored on a storage medium 301. The storage medium 301 can be any storage medium from the related or prior art.

What is claimed is:

1. A computer-implemented method for generating a map representation for a vehicle, comprising the following steps:
receiving environmental sensor data of at least one environmental sensor of the vehicle using an onboard map generation system, wherein the environmental sensor data at least partially represent an environment of the vehicle;
receiving map data of an electronic road map using the onboard map generation system, wherein the map data at least partially represent a traffic infrastructure within the environment of the vehicle, and wherein the map data are based on radar data; and
generating the map representation of the environment of the vehicle based on the environmental sensor data and the map data, using the onboard map generation system.

2. The method according to claim 1, further comprising:
receiving radar data of at least one radar sensor of the vehicle, wherein the radar data at least partially represent the environment of the vehicle, and wherein the map representation is generated taking into account the radar data.

3. The method according to claim 1, wherein the map data of the electronic road map are based on at least one of: aggregated radar data, or filtered radar data.

4. The method according to claim 1, wherein the map data include information from the following list: radar cross section, frame counter, mean position, covariance.

5. The method according to claim 1, wherein the environmental sensor data include at least one of: image data, or video data.

6. The method according to claim 1, wherein the method further comprises:
converting the environmental sensor data into bird's-eye view (BEV) features using a transformer of a BEV backbone of the onboard map generation system;
converting the radar data into BEV features using a radar perception encoder of the onboard map generation system;
extracting map features based on the BEV features of the environmental sensor data, the BEV features of the radar data, and BEV features of the map data of the electronic road map using a map head of the onboard map generation system; and
generating the map representation based on the map features using a map prediction module of the onboard map generation system.

7. The method according to claim 6, further comprising:
generating the BEV features of the map data of the electronic road map using a radar encoder of the onboard map generation system.

8. The method (100) according to claim 7, further comprising:
fusing the BEV features of the map data of the electronic road map with the BEV features of the environmental sensor data and the BEV features of the radar data.

9. The method according to claim 8, wherein the fusing of the BEV features of the map data of the electronic road map with the BEV features of the environmental sensor data and the BEV features of the radar data is effected using a process from the following list: addition of features, concatenation of features and processing by an artificial intelligence, cross attention.

10. A computing unit configured to generate a map representation for a vehicle the computing unit configured to perform the following steps comprising:
receiving environmental sensor data of at least one environmental sensor of the vehicle using an onboard map generation system, wherein the environmental sensor data at least partially represent an environment of the vehicle;
receiving map data of an electronic road map using the onboard map generation system, wherein the map data at least partially represent a traffic infrastructure within the environment of the vehicle, and wherein the map data are based on radar data; and
generating the map representation of the environment of the vehicle based on the environmental sensor data and the map data, using the onboard map generation system.

11. A non-transitory storage medium on which is stored a computer program including commands for generating a map representation for a vehicle, the commands, when executed by a data processor, causing the data processor to perform the following steps comprising:
receiving environmental sensor data of at least one environmental sensor of the vehicle using an onboard map generation system, wherein the environmental sensor data at least partially represent an environment of the vehicle;
receiving map data of an electronic road map using the onboard map generation system, wherein the map data at least partially represent a traffic infrastructure within the environment of the vehicle, and wherein the map data are based on radar data; and
generating the map representation of the environment of the vehicle based on the environmental sensor data and the map data, using the onboard map generation system.
